(19) United States
(12) Patent Application Publication
(10) Pub. No.: US 2023/0124650 A1
(43) Pub. Date: Apr. 20, 2023

(54) OPTICAL SYSTEM AND LASER MACHINING DEVICE

(71) Applicant: Tokyo Seimitsu Co., Ltd., Hachioji-shi (JP)

(72) Inventor: Kazushi HYAKUMURA, Hachioji-shi (JP)

(73) Assignee: Tokyo Seimitsu Co., Ltd., Hachioji-shi (JP)

(21) Appl. No.: 18/047,389

(22) Filed: Oct. 18, 2022

(30) Foreign Application Priority Data
Oct. 19, 2021 (JP) 2021-170863

(51) Int. Cl. B23K 26/06

(52) U.S. Cl. CPC B23K 26/0648; B23K 26/0643

(57) ABSTRACT

An optical system that relays light to a machining lens to be used for machining on a workpiece includes a spatial light modulator and a second lens arranged between the spatial light modulator and the machining lens, a distance D from the second lens to a machining lens pupil is D = f₂ - Mf₂, and a distance D1 from the spatial light modulator to the second lens is D1 = f₂ - f₂/M, and the spatial light modulator has a conjugate relation with the machining lens pupil of the machining lens, where f₂ is a focal length of the second lens, and M is a projection magnification from the spatial light modulator to the machining lens pupil of the machining lens.

### CROSS-REFERENCE TO RELATED APPLICATIONS

This application claims the priority benefit under 35 U.S.C. § 119 of Japanese Patent Application No. 2021-170863 filed on Oct. 19, 2021, which is hereby incorporated in its entirety by reference.

### BACKGROUND OF THE INVENTION

### Field of the Invention

The presently disclosed subject matter relates to an optical system and a laser machining device and particularly relates to an optical system and a laser machining device that condense laser light to a workpiece and perform laser machining.

### Description of the Related Art

Conventionally, a technology has been known that forms a cutting starting point region from which cutting is started inside a workpiece along a planned cutting line of the workpiece by setting a focal point inside the workpiece and radiating laser light (see Japanese Patent Application Laid-Open No. 2017-131942, for example).

In the laser machining device described in Japanese Patent Application Laid-Open No. 2017-131942, a pair of lenses of a 4F lens unit constitute a both-side telecentric optical system in which reflection plane of a reflective spatial light modulator and an incident pupil plane of a condenser lens unit are set to have an imaging relation.

Patent Literature: Japanese Patent Application Laid-Open No. 2017-131942

### SUMMARY OF THE INVENTION

In a laser machining device as described above, in addition to a machining optical system such as a condenser lens unit, an observation optical system and an optical system such as an automatic focus (AF) optical system (hereinafter, referred to as an auxiliary optical system) is provided. It is necessary for an auxiliary optical system as described above to be provided between a 4F optical system and a machining optical system.

FIG. 10 illustrates an example of an optical system in a laser machining device. Referring to FIG. 10, a pair of lenses L1 and L2 constitutes afocal optical system (4F optical system). Lenses on far and near sides from a machining lens pupil 26a of the pair of lenses L1 and L2 are referred to as a first lens L1 and a second lens L2, respectively, assuming that focal lengths of the first lens L1 and the second lens L2 are f₁ and f₂, respectively.

As illustrated in FIG. 10, in an optical system having a 4F optical system, in order to secure a space for an auxiliary optical system, the focal length f₂ of the second lens L2 on the side near the machining lens pupil 26a of the pair of lenses included in the 4F optical system is required to be longer.

The size of the optical system in the laser machining device is described below. The range of a magnification M from a spatial light modulator 24 to the machining lens pupil 26a substantially depends on the sizes of the spatial light modulator 24 and the machining lens pupil 26a. The magnification M from the spatial light modulator 24 to the machining lens pupil 26a is expressed by the following expression (1). [Expression 1]

$$M = - \frac{{f}_{2}}{{f}_{1}}$$

As illustrated in FIG. 10, the machining lens pupil 26a is arranged at a rear side focal position of the second lens L2, and the spatial light modulator 24 is arranged at a front side focal position of the first lens L1. In other words, there is a conjugate relation between the spatial light modulator 24 and the machining lens pupil 26a. Therefore, the distance L from the spatial light modulator 24 to the machining lens pupil 26a is expressed by the following expression (2).

$$L = 2 \times \left({f}_{1} + {f}_{2}\right)$$

As expressed in the expression (1), when the magnification M is determined, the focal length f₁ of the first lens L1 is determined in turn. In order to provide an auxiliary optical system between the second lens L2 and the machining lens pupil 26a, as the focal length f₂ of the second lens L2 is increased, the focal length f₁ of the first lens L1 is necessarily increased, from the expression (1). For that, as expressed in the expression (2), the distance L from the spatial light modulator 24 to the machining lens pupil 26a is increased, which increases the size of the optical system in the laser machining device.

Expressing the distance L by handling the focal length f₂ of the second lens L2 and magnification M as parameters, the following expression (3) is obtained. [Expression 2]

$$L = 2 ⋅ \left(1 - \frac{1}{M}\right) ⋅ {f}_{2} = 2 ⋅ \left(1 - \frac{1}{M}\right) ⋅ D$$

Reference character D designates a distance from the second lens L2 to the machining lens pupil 26a, and the distance D is equal to the focal length f₂ of the second lens L2 in the example illustrated in FIG. 10.

Here, assuming that the f₂ = 200 mm and M = -⅔, f₁ = 300 mm from the expression (1), and L = 1,000 mm from the expression (3).

Also, assuming that f₂ = 300 mm and M = -⅔, L = 1500 mm from the expression (3), and the total length of the optical system in the laser machining device is extremely long.

The optical system having a longer total length as described above in the laser machining device is susceptible to an effect of an angle error of an optical element, which may lower the stability of the laser machining. Furthermore, such an optical system may be susceptible to an effect of thermal expansion of the laser machining device, which may lower the stability of laser machining.

The presently disclosed subject matter has been made in view of these circumstances, and it is an object of the presently disclosed subject matter to reduce the size of an optical system in a laser machining device so as to provide the optical system and a laser machining device which may increase the stability of the laser machining.

In order to achieve the object, a first aspect of the presently disclosed subject matter is an optical system that relays light to a machining lens to be used for machining on a workpiece, the optical system including a spatial light modulator, and a second lens arranged between the spatial light modulator and the machining lens, wherein a distance D from the second lens to a machining lens pupil is D = f₂ - Mf₂, and a distance D1 from the spatial light modulator to the second lens is D1 = f₂ - f₂/M, and the spatial light modulator has a conjugate relation with the machining lens pupil of the machining lens, where f₂ is a focal length of the second lens, and M is a projection magnification from the spatial light modulator to the machining lens pupil of the machining lens.

A second aspect of the presently disclosed subject matter is the optical system according to the first aspect further including an afocal optical system including a first lens and the second lens, wherein the first lens is arranged upstream of the spatial light modulator.

A third aspect of the presently disclosed subject matter is the optical system according to the first aspect further including an afocal optical system including a first lens and the second lens, wherein the first lens is arranged such that light entering the spatial light modulator passes through the first lens, and reflected light reflected by the spatial light modulator after entering the spatial light modulator passes through the first lens.

A fourth aspect of the presently disclosed subject matter is the optical system according to the first aspect, wherein the spatial light modulator has a condensing function, and a focal length f₁ of the spatial light modulator is f₁ = -f₂/M.

A fifth aspect of the presently disclosed subject matter is a laser machining device including a machining lens, and an optical system according to any one of the first to fourth aspects, wherein the spatial light modulator modulates laser light that is radiated with its focal point set inside the workpiece for forming a laser machining region inside the workpiece, and the optical system relays the laser light modulated by the spatial light modulator to the machining lens.

According to the presently disclosed subject matter, a distance from a spatial light modulator to a machining lens pupil can be reduced, and stability of laser machining can be increased.

### BRIEF DESCRIPTION OF THE DRAWINGS

FIG. 1 is a diagram illustrating a laser machining device according to a first embodiment of the presently disclosed subject matter;

FIG. 2 is a block diagram illustrating a control device;

FIG. 3 is a conceptual diagram for explaining a laser machining region formed in vicinity of a focal point inside a wafer;

FIG. 4 is a conceptual diagram for explaining a laser machining region formed in vicinity of a focal point inside a wafer;

FIG. 5 is a conceptual diagram for explaining a state that multi-layered laser machining region is formed inside a wafer;

FIG. 6 is a diagram illustrating an example of a relay optical system according to the first embodiment of the presently disclosed subject matter;

FIG. 7 is a diagram illustrating an example of a relay optical system according to a second embodiment of the presently disclosed subject matter;

FIG. 8 is a diagram illustrating a laser machining device according to a third embodiment of the presently disclosed subject matter;

FIG. 9 is a diagram illustrating a relay optical system according to the third embodiment of the presently disclosed subject matter; and

FIG. 10 is a diagram illustrating an example of an optical system in a laser machining device.

### DETAILED DESCRIPTION OF THE EMBODIMENTS

Embodiments of an optical system and a laser machining device according to the presently disclosed subject matter are described below with reference to attached drawings.

### First Embodiment

### Laser Machining Device

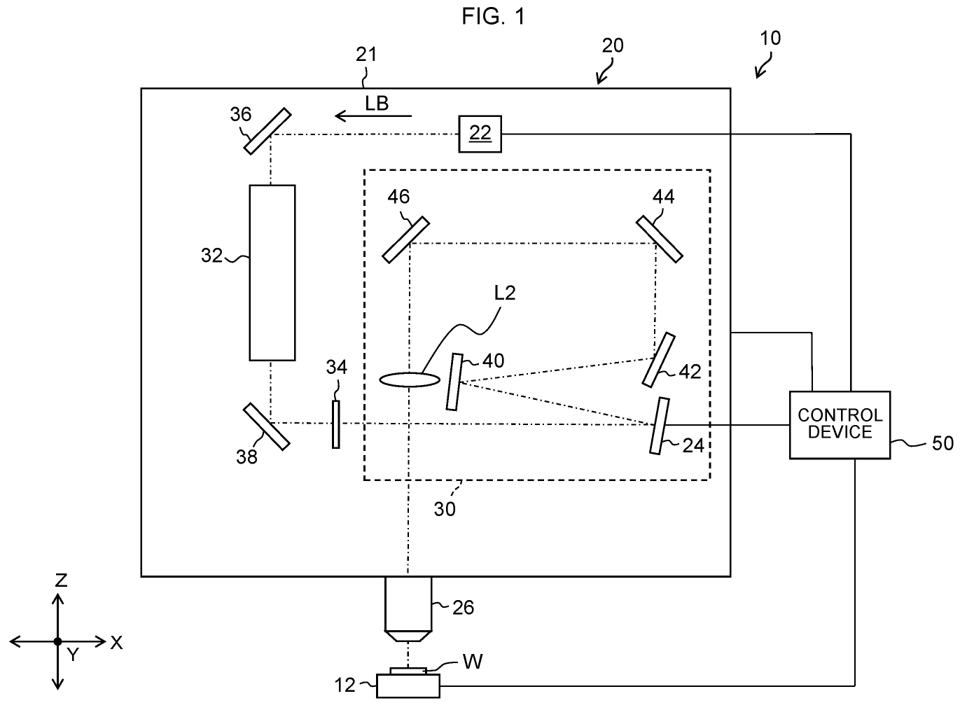

FIG. 1 is a diagram illustrating a laser machining device according to a first embodiment of the presently disclosed subject matter.

As illustrated in FIG. 1, a laser machining device 10 according to this embodiment includes a stage 12, a machining device body (optical system unit) 20, a machining lens 26, and a control device 50. This embodiment describes a case where machining device body 20 and the control device 50 are configured separately; the presently disclosed subject matter is not limited to the case. For example, the machining device body 20 may include a part or all of the control device 50.

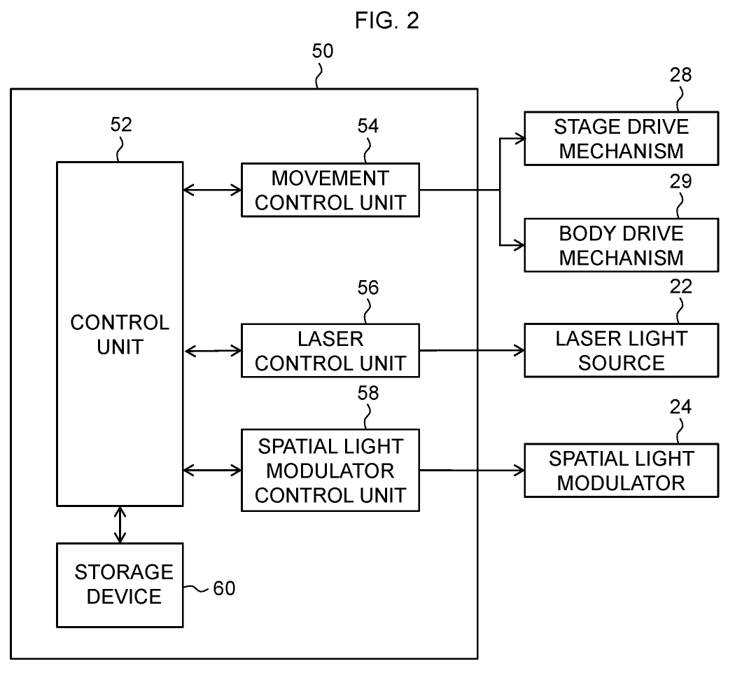

The stage 12 sucks and holds a workpiece. The stage 12 is configured to be movable in an X direction and a θ direction by a stage drive mechanism 28 (see FIG. 2). The stage drive mechanism 28 may include any of a variety of mechanism such as a ball screw mechanism and a linear motor mechanism, for example. Operations of the stage drive mechanism 28 are controlled by the control device 50 (a movement control unit 54 in FIG. 2).

In FIG. 1, three directions of X, Y and Z are orthogonal to each other, and, among them, the X direction and the Y direction are horizontal directions, and the Z direction is a vertical direction. Also, the θ direction is a direction of rotation about a vertical direction axis (Z axis) as a rotation axis.

According to this embodiment, a workpiece is a semiconductor wafer (“wafer” hereinafter) W such as a silicon wafer. The wafer W is divided into a plurality of regions by planned cutting lines arranged in a grid pattern, and any of various devices included in a semiconductor chip are formed in each of the divided regions. This embodiment describes a case where a workpiece is the wafer W; the presently disclosed subject matter is not limited to the case. For example, the workpiece may be a glass substrate, a piezoelectric ceramic substrate, or the like.

The wafer W has a front surface (device surface) having a device thereon; a back griding tape (BG tape) having a tackiness agent is pasted to the front surface. The wafer W is mounted on the stage 12 with its back surface facing upward. The thickness of the wafer W is not particularly limited but is, as an example, greater than or equal to 700 µm or falls within a range of 700 µm to 800 µm.

Instead, the wafer W may have one surface with a dicing tape having a tackiness agent pasted thereto, and the wafer W integrated into a frame through the dicing tape may be mounted to the stage 12.

The machining device body 20 includes a cabinet 21, a laser light source 22, a spatial light modulator 24, a relay optical system 30, a beam expander 32, and a λ/2 wave plate 34.

Inside of the cabinet 21, the laser light source 22, the spatial light modulator 24, the relay optical system 30, the beam expander 32, and the λ/2 wave plate 34 are arranged. Instead, the laser light source 22 may be arranged outside the cabinet 21 (for example, on the ceiling or a side surface of the cabinet 21 or the like). Also, the machining lens 26 is removably attached to a bottom surface of the cabinet 21.

The machining device body 20 is configured to be movable in the Y direction and the Z direction by a body drive mechanism 29 (see FIG. 2). The body drive mechanism 29 may include any of various mechanisms such as a ball screw mechanism, a linear motor mechanism or the like, for example. Operations of the body drive mechanism 29 are controlled by the control device 50 (by the movement control unit 54 in FIG. 2). Thus, in accordance with a machining position (a position where a laser machining region is to be formed) on the wafer W, the machining device body 20 can be moved in the Y direction and/or the Z direction. Therefore, by changing the position of the focal point of the laser light LB condensed by the machining lens 26, the laser machining region can be formed at a desired position on the wafer W.

The laser light source (infrared (IR) laser light source) 22 emits (radiates) laser light LB for machining to form a laser machining region inside the wafer W. The operation of emitting laser light LB by the laser light source 22 is controlled by the control device 50 (laser control unit 56 in FIG. 2). For example, conditions for the laser light LB include the light source being a semiconductor laser excitation Nd:YAG (Yttrium Aluminum Garnet) laser, the wavelength being 1.1 µm, the laser light LB spot cross section being 3.14 × 10⁻⁸ cm², the oscillation form being Q switch pulses, the cyclic frequency being 80 kHz to 200 kHz, the pulse width being 180 ns to 370 ns, and the output being 8W.

The laser light LB emitted from the laser light source 22 is reflected by a total reflection mirror 36 and reaches the beam expander 32. The beam expander 32 expands the laser light emitted from the laser light source 22 so as to have a proper beam diameter for the spatial light modulator 24.

The laser light LB adjusted by the beam expander 32 is reflected by a total reflection mirror 38 and reaches the spatial light modulator 24 via the λ/2 wave plate 34. The λ/2 wave plate 34 adjusts a laser light LB incident plane of polarization to the spatial light modulator 24.

The spatial light modulator 24 is a phase modulation type spatial light modulator that includes a light modulating surface having a plurality of two-dimensionally arranged pixels (micro modulation elements) thereon and, for each of the pixels, modulates a phase of light entering the light modulating surface. As the spatial light modulator 24, a reflective liquid crystal (liquid crystal on silicon: LCOS) spatial light modulator (SLM) is used, for example. The spatial light modulator 24 modulates a phase of light entering the light modulating surface for each pixel based on a predetermined modulation pattern defined by a spatial light modulator control unit 58, which will be described below, and emits the modulated light toward a predetermined direction.

Operations of the spatial light modulator 24 and the modulation pattern presented by the spatial light modulator 24 are controlled by the control device 50 (spatial light modulator control unit 58 in FIG. 2). The modulation pattern may be a pattern (two-dimensional information) in which control values (phase change amounts) each corresponding to each of the plurality of pixels included in the light modulating surface of the spatial light modulator 24 are two-dimensionally distributed or may include coefficient information when a modulation within a modulation region (light modulating surface) is expressed by a certain function.

The spatial light modulator 24 is arranged at a position that is optically conjugate with a lens pupil (exit pupil) 26a of the machining lens 26.

The optical system (relay optical system) 30 includes an optical system for relaying laser light LB modulated by the spatial light modulator 24 to the machining lens 26; the relay optical system 30 is provided on an optical path for laser light LB between the λ/2 wave plate 34 and the machining lens 26; the relay optical system 30 includes the spatial light modulator 24. The relay optical system 30 includes at least one lens L2. The relay optical system 30 includes a both-side telecentric optical system and projects the laser light LB modulated by the spatial light modulator 24 to the machining lens 26.

This relay optical system 30 includes a both-side telecentric optical reduction system, and the absolute value of the projection magnification M (hereinafter, also simply called “magnification”) is lower than 1 and is M = -⅔ as an example.

The machining lens 26 is an objective lens (condensing optical system) that condenses laser light LB to inside of the wafer W. This machining lens 26 has a numerical aperture (NA) equal to 0.65, for example.

The total reflection mirrors 36 to 46 illustrated in FIG. 1 are arranged for bending the optical path of laser light LB, and the number and layout thereof are not limited to the example illustrated in FIG. 1.

The machining device body 20 further includes an alignment optical system for performing alignment with the wafer W, an observation optical system, and an AF optical system for keeping a constant distance (working distance) between the wafer W and a machining lens 26, though not illustrated in the figure.

### Control Device

FIG. 2 is a block diagram illustrating the control device 50. The control device 50 is implemented by a general-purpose computer such as a personal computer, a microcomputer or the like, for example.

The control device 50 includes a processor (such as a central processing unit (CPU)), a read only memory (ROM), a random access memory (RAM), a storage device 60, and an input/output interface.

In the control device 50, various programs such as a control program stored in the storage device 60 are decompressed in the RAM, and the program decompressed in the RAM is executed by a processor so that functions of the components within the control device 50 illustrated in FIG. 2 are implemented, and various kinds of arithmetic operation processing and control processing are executed through the input/output interface.

As illustrated in FIG. 2, the control device 50 functions as a control unit 52, a movement control unit 54, a laser control unit 56, and a spatial light modulator control unit 58.

The control unit 52 generally controls each of the components included in the control device 50 (including the movement control unit 54, the laser control unit 56, the spatial light modulator control unit 58, and the storage device 60).

The movement control unit 54 controls relative movements of the stage 12 and the machining device body 20. The movement control unit 54 outputs a control signal that controls movements of the stage 12 in the X direction and in the θ direction to the stage drive mechanism 28 and outputs a control signal that controls movements of the machining device body 20 in the Y direction and the Z direction to the body drive mechanism 29.

The laser control unit 56 controls emission of laser light LB. The laser control unit 56 outputs control signals that controls a wavelength, pulse width, intensity, emission timing, cyclic frequency and the like of laser light LB to the laser light source 22.

The spatial light modulator control unit 58 outputs a control signal that controls operations of the spatial light modulator 24 to the spatial light modulator 24. In other words, the spatial light modulator control unit 58 performs control that causes the spatial light modulator 24 to present a predetermined modulation pattern. The spatial light modulator control unit 58 properly sets a modulation pattern to be displayed by the spatial light modulator 24 so that laser light LB can be modulated (for example, the intensity, amplitude, phase, polarization or the like of laser light L can be modulated). Also, the spatial light modulator control unit 58 may set a modulation pattern for modulating laser light LB in the spatial light modulator 24 such that the aberration of the laser light LB occurring at a position where the focal point of the laser light LB is set inside the wafer W is lower than or equal to a predetermined aberration.

The storage device 60 is a device that stores various data including a control program for the control device 50 and the like and includes, for example, a hard disk drive (HDD) or a solid state drive (SSD).

### Laser Machining

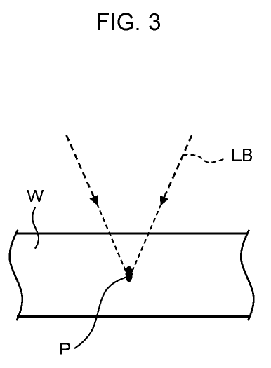

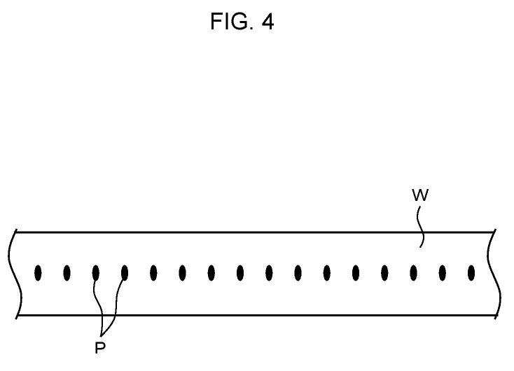

FIG. 3 and FIG. 4 are conceptual diagrams for explaining a laser machining region to be formed in vicinity of a focal point inside a wafer.

FIG. 3 illustrates a state that the laser light LB entering inside of the wafer W forms laser machining regions P at focal points. FIG. 4 illustrates a state that discontinuous laser machining regions P, P, ... are formed in line after the wafer W is moved horizontally under a pulsed laser light LB. In this state, the wafer W is torn (cut) naturally from the laser machining regions P as a starting point, or a small external force is applied so that the wafer W is torn from the laser machining regions P as a starting point. In this case, the wafer W is easily divided into chips without occurrence of chipping of the front and back surfaces.

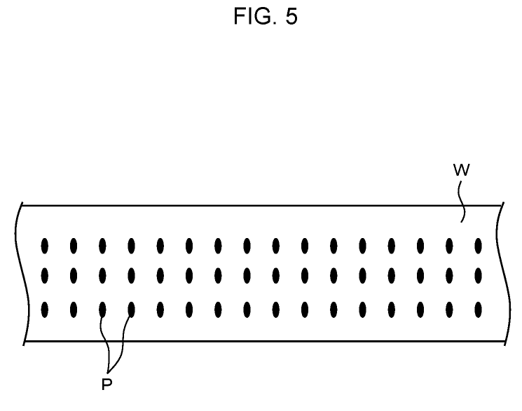

FIG. 5 is a conceptual diagram for explaining a state that multi-layered laser machining regions are formed inside a wafer.

In a case where the thickness of the wafer W is high and when the wafer w may not be torn (cut) with just one layer of the laser machining regions P, multi-layered laser machining regions P can be formed as illustrated in FIG. 5 by changing the focal point of the laser light LB in the direction of thickness of the wafer W and scanning the laser light LB over the wafer W a plurality of number of times. In this way, starting from the multi-layered laser machining regions P, the wafer W is torn naturally or is torn with application of a small external force thereto.

Although FIG. 3 to FIG. 5 illustrate a state that discontinuous laser machining regions P, P, ... are formed with pulsed laser light LB, continuous laser machining region P may be formed under continuous waves of the laser light LB.

### Relay Optical System

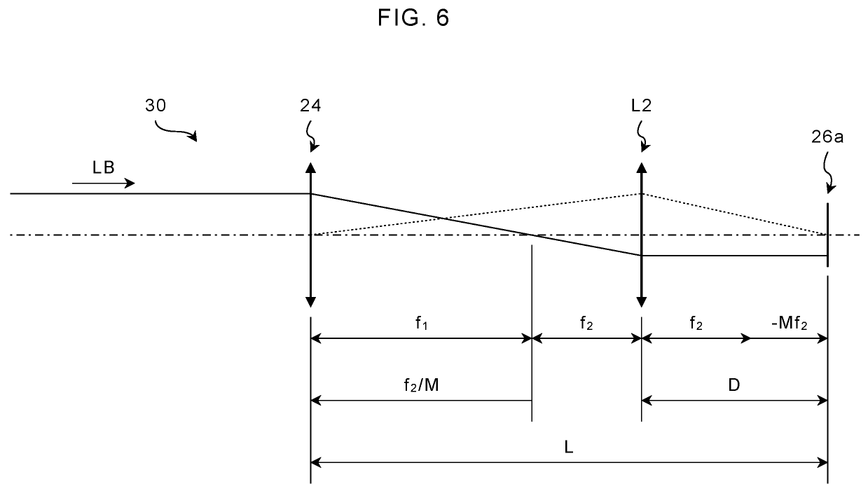

FIG. 6 is a diagram illustrating an example of a relay optical system according to the first embodiment of the presently disclosed subject matter. In FIG. 6, total reflection mirrors 40, 42, 44 and 46 are omitted in the relay optical system 30 illustrated in FIG. 1.

As illustrated in FIG. 6, in the relay optical system 30, the spatial light modulator 24 and a lens (hereinafter, referred to as “second lens”) L2 are arranged in order from an upstream side far away from the machining lens pupil 26a.

It is assumed hereinafter that the magnification from the spatial light modulator 24 to the machining lens pupil 26a is M, and the focal length of the second lens L2 is f₂.

As illustrated in FIG. 6, the focal length f₂ of the second lens L2 is defined such that a distance D from the second lens L2 to the machining lens pupil 26a is D = f₂ - Mf₂. Also, the spatial light modulator 24 is arranged at a distance of D1 = f₁ + f₂ = f₂ - f₂/M on the upstream side of the second lens L2 such that the machining lens pupil 26a and the spatial light modulator 24 can have a conjugate relation.

The spatial light modulator 24 according to this embodiment is then given power such that the focal length f₁ is f₁ = -f₂/M. In the spatial light modulator 24, it is assumed that a pattern for giving power for achieving focal length f₁ = -f₂/M is Pattern 1.

According to this embodiment, wavefront manipulation by the spatial light modulator 24 is achieved by adding a predetermined modulation pattern to Pattern 1. In other words, in this embodiment, the function of giving power to the spatial light modulator 24 also serves as the modulation function of the spatial light modulator 24.

A size of the relay optical system 30 according to this embodiment is described below. As illustrated in FIG. 6, the distance D from the second lens L2 to the machining lens pupil 26a is D = f₂ - Mf₂. As its variation, the following expression (4) is acquired. [Expression 3]

$${f}_{2} = \frac{D}{1 - M}$$

By substituting the expression (4) into the focal length f₁ = -f₂/M of the spatial light modulator 24, the following expression (5) is acquired. [Expression 4]

$${f}_{1} = \frac{- {f}_{2}}{M} = \frac{- D}{M \left(1 - M\right)}$$

Therefore, the distance L from the spatial light modulator 24 to the machining lens pupil 26a is expressed by the following expression (6). [Expression 5]

$$L = {f}_{1} + {f}_{2} + D = \frac{D \left(M - 1\right)}{M}$$

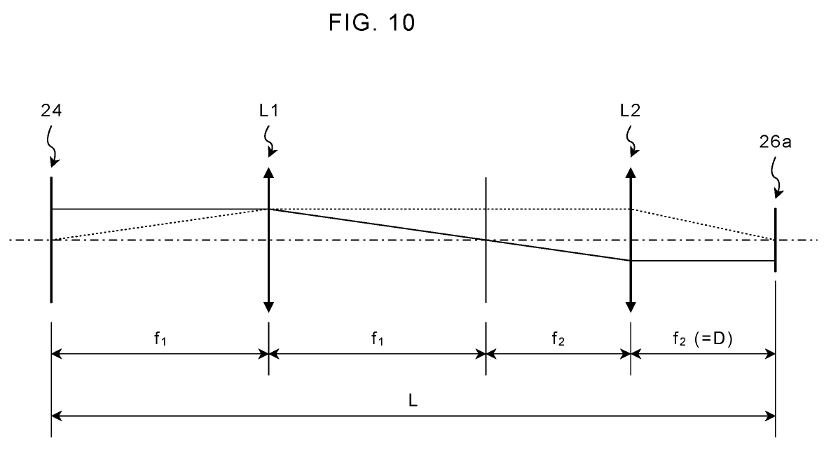

In the expression (6), assuming the distance D from the second lens L2 to the machining lens pupil 26a is D = 200 mm and the magnification is M = -⅔, L = 500 mm is acquired, indicating that the distance L from the spatial light modulator 24 to the machining lens pupil 26a is ½ of the example illustrated in FIG. 10.

According to this embodiment, giving power to the spatial light modulator 24 allows reduction of the distance L from the spatial light modulator 24 to the machining lens pupil 26a. Thus, the size of the optical system in the laser machining device can be reduced, and the stability of the laser machining can be increased.

Further, according to this embodiment, since no 4F optical system exists but only the second lens L2 exists between the spatial light modulator 24 and the machining lens, a more compact and simpler optical system can be acquired.

### Examples of Numerical Values

Referring to FIG. 6, expressing the distance L from the spatial light modulator 24 to the machining lens pupil 26a by using the focal length f₂ of the second lens L2, the following expression (7) is acquired. [Expression 6]

$$L = 2 ⋅ {f}_{2} - M ⋅ {f}_{2} - \frac{{f}_{2}}{M} = \left(2 - M - \frac{1}{M}\right) ⋅ {f}_{2}$$

In the expression (7), assuming that M = -⅔ and f₂ = 200 mm, L = 833.33 mm. Then, the distance D between the second lens L2 and the machining lens pupil 26a is D = f₂·(1 - M) = 333 mm.

On the other hand, in the optical system illustrated in FIG. 10, since the distance D between the second lens L2 and the machining lens pupil 26a is D = f₂, the distance L from the spatial light modulator 24 to the machining lens pupil 26a is expressed by the following expression (8). [Expression 7]

$$L = 2 ⋅ \left(1 - \frac{1}{M}\right) ⋅ {f}_{2}$$

According to the first embodiment, the distance D from the second lens L2 to the machining lens pupil 26a is expressed by the following expression (9).

D=f₂·(1 - M) (9)

In the 4F optical system illustrated in FIG. 10, although the distance D from the second lens L2 to the machining lens pupil 26a is D = f₂, the expression (9) instead of f₂ is substituted into the expression (8) so as to acquire D = f₂·(1 - M) as in the first embodiment. Thus, the following expression (10) is obtained. [Expression 8]

$${L}^{′} = 2 ⋅ \left(1 - \frac{1}{M}\right) ⋅ \left(1 - M\right) ⋅ {f}_{2} = 2 ⋅ \left(2 - M - \frac{1}{M}\right) ⋅ {f}_{2} = 2 ⋅ L$$

Here, reference character L′ designates a length from the spatial light modulator 24 to the machining lens pupil 26a required for acquiring the distance D = f₂·(1 - M) from the second lens L2 to the machining lens pupil 26a in the 4F optical system illustrated in FIG. 10.

In the expression (10), assuming M = -⅔ and f₂ = 200 mm, L′ = 1,666.7 mm.

As described above, according to the first embodiment, the distance from the spatial light modulator 24 to the machining lens pupil 26a can be ½.

### Second Embodiment

Next, a second embodiment of the presently disclosed subject matter is described. In the following description, like references refer to like parts in the first and second embodiments, and the description thereof may be omitted.

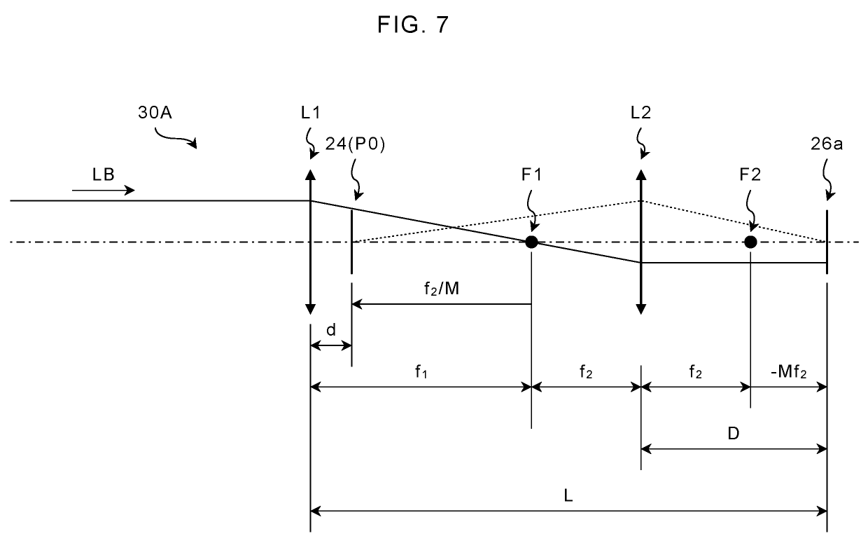

FIG. 7 is a diagram illustrating an example of a relay optical system according to the second embodiment of the presently disclosed subject matter. As in FIG. 6, the total reflection mirrors 40, 42, 44 and 46 for bending the optical path of laser light LB are omitted in FIG. 7.

As illustrated in FIG. 7, in a relay optical system 30A according to this embodiment, the first lens L1, the spatial light modulator 24 and the second lens L2 are arranged in order from the upstream side far away from the machining lens pupil 26a.

According to this embodiment, the first lens L1 on the upstream side is provided with the condenser lens function of the spatial light modulator 24.

As illustrated in FIG. 7, the distance from the first lens L1 to the second lens L2 is f₁ + f₂, and there is provided a 4F optical system (afocal optical system) including (constituted by) the first lens L1 and the second lens L2. Then, the machining lens pupil 26a is arranged on the downstream side by -Mf₂ far from the focal position F2 on the rear side of the second lens L2.

In this case, as illustrated in FIG. 7, a position PO that is conjugate with the machining lens pupil 26a is in the 4F optical system, that is, between the first lens L1 and the second lens L2. The spatial light modulator 24 is arranged at a position PO that is conjugate with the machining lens pupil 26a.

Specifically, the position PO that is conjugate with the machining lens pupil 26a is a position at f₂/M on the upstream side from the rear side focal position F1 of the first lens L1 (front side focal position of the second lens L2).

According to this embodiment, the same modulation pattern as that in the typical 4F optical system can be used since giving power to the spatial light modulator 24 is not necessary.

From the positional relation among the first lens L1, the spatial light modulator 24 and the second lens L2 in FIG. 7, the following expression (11) is acquired. [Expression 9]

$${f}_{1} > \frac{- {f}_{2}}{M}$$

According to this embodiment, in order to secure the magnification M from the spatial light modulator 24 to the machining lens pupil 26a, the focal length f₁ of the first lens L1 is required to be long. Also, the laser light LB enters to the spatial light modulator 24 diagonally with respect to the light modulating surface. Thus, according to the second embodiment, the distance d between the spatial light modulator 24 and the first lens L1 is required to be long to a certain extent such that the first lens L1 does not block reflected light from the spatial light modulator 24. Therefore, the focal length f₁ of the first lens L1 is determined by taking the magnification M from the spatial light modulator 24 to the machining lens pupil 26a and a required interval (distance d) between the first lens L1 and the spatial light modulator 24 into account.

With the focal length f₁ of the first lens L1 and the focal length f₂ of the second lens L2 defined, the required entering beam diameter of the laser light LB that enters the first lens L1 is determined. Therefore, required beam diameter can be formed by the afocal optical system or beam expander 32 on the upstream side of the relay optical system 30A.

A size of the relay optical system 30 according to this embodiment is described below. As illustrated in FIG. 7, according to this embodiment, the distance L from the first lens L1 to the machining lens pupil 26a is expressed by the following expression (12). L = f₁ + 2·f₂ - M·f₂ (12)

In the expression (12), assuming that D = 200 mm, f₁ = 230 mm, f₂ = 120 mm, and the distance d between the first lens L1 and the spatial light modulator 24 is d = 50 mm, L = 550 mm.

According to this embodiment, by providing the first lens L1 with the condensing function, the distance L from the first lens L1 to the machining lens pupil 26a can be reduced. Thus, the size of the optical system in the laser machining device can be reduced, and the stability of the laser machining can be increased. Also, by providing the first lens L1 with the condensing function, the load on the spatial light modulator 24 can be reduced.

Further, according to this embodiment, an optical system that is more compact and simpler can be acquired since no 4F optical system exists but only the second lens L2 exists between the spatial light modulator 24 and the machining lens.

### Third Embodiment

Next, a third embodiment of the presently disclosed subject matter is described. In the following description, like references refer to like parts in the first, second and third embodiments, and the description thereof may be omitted.

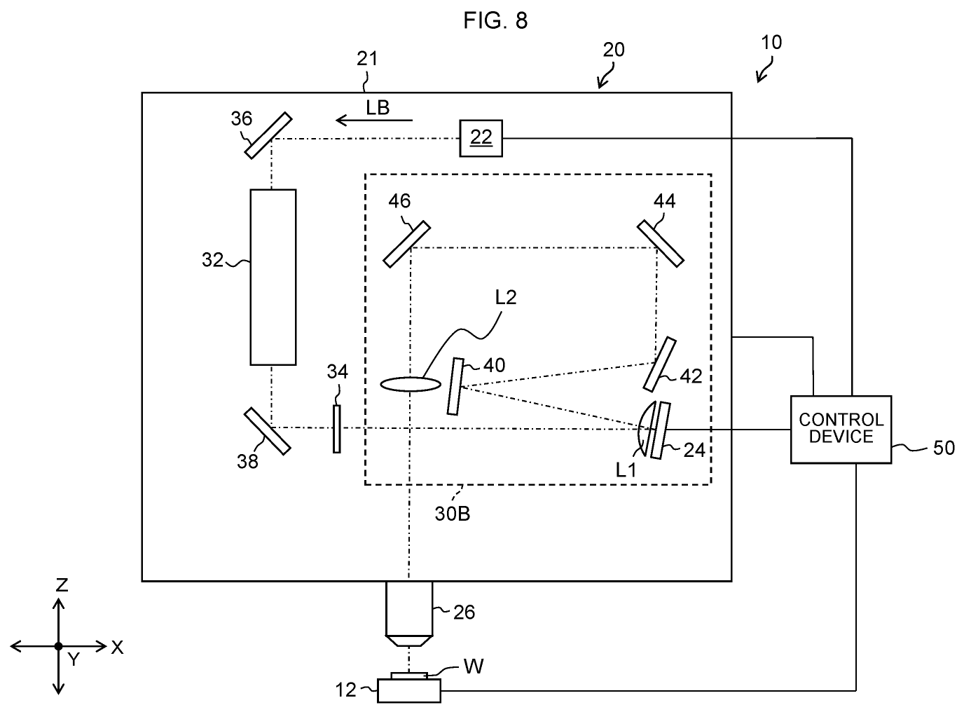

FIG. 8 is a diagram illustrating a laser machining device according to the third embodiment of the presently disclosed subject matter.

As illustrated in FIG. 8, in a relay optical system 30B according to this embodiment, the first lens L1 is arranged closely to the light modulating surface of the spatial light modulator 24. In other words, the first lens L1 is arranged such that laser light LB passes through the first lens L1 twice.

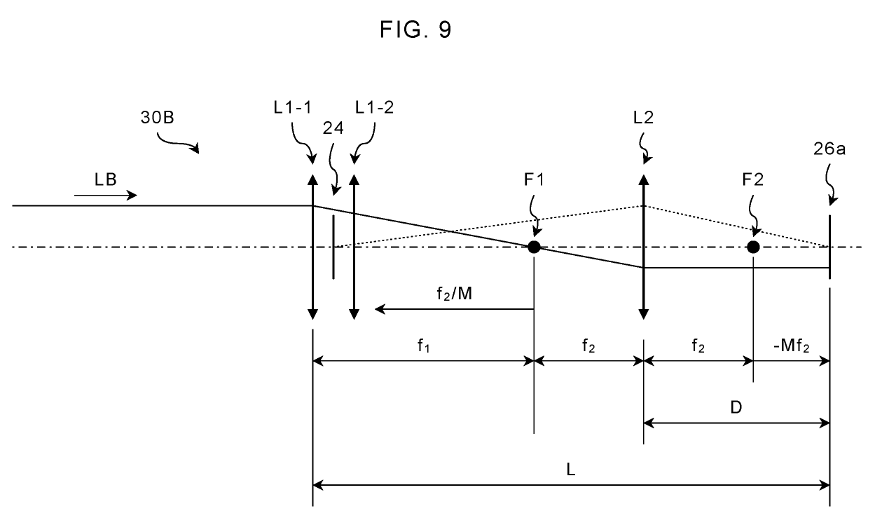

FIG. 9 is a diagram illustrating an example of the relay optical system according to the third embodiment of the presently disclosed subject matter. As in FIG. 6 and FIG. 7, the total reflection mirrors 40, 42, 44 and 46 for bending the optical path of laser light LB are omitted in FIG. 9.

As illustrated in FIG. 9, in the relay optical system 30B according to this embodiment, laser light LB passes through the first lens L1, is then reflected by the spatial light modulator 24, and passes through the first lens L1 again. After that, the laser light LB passes through the second lens L2 and reaches the machining lens pupil 26a. The lenses included in the first lens L1 through which the laser light LB passes is designated by references L1-1 and L1-2 sequentially in FIG. 9.

As illustrated in FIG. 9, the distance from the first lens L1-1 to the second lens L2 is f₁ + f₂, and there is provided a 4F optical system (afocal optical system) including (constituted by) the first lens L1-1, L1-2 and the second lens L2. Then, the machining lens pupil 26a is arranged on the downstream side by -Mf₂ far from the rear side focal position F2 of the second lens L2.

Also, the spatial light modulator 24 is arranged at a position that is conjugate with the machining lens pupil 26a, that is, arranged at a position at f₂/M on the upstream side from the rear side focal position F1 of the first lens L1 (front side focal position of the second lens L2).

According to this embodiment, the same modulation pattern as that in the typical 4F optical system can be used since giving power to the spatial light modulator 24 is not necessary, like the second embodiment.

As illustrated in FIG. 9, according to this embodiment, the distance L from the first lens L1 to the machining lens pupil 26a is expressed by the same expression (12) as in the second embodiment.

According to this embodiment, the first lens L1 is arranged closely to the spatial light modulator 24 so that the distance L from the first lens L1 to the machining lens pupil 26a can be reduced. Thus, the size of the optical system of the laser machining device can be reduced, and the stability of the laser machining can be increased.

Further, according to this embodiment, an optical system that is more compact and simpler can be acquired since the first lens L1-2 and the second lens L2 between the spatial light modulator 24 and the machining lens do not constitute a 4F optical system (afocal optical system).

Also, according to this embodiment, the distance between the first lens L1 and the spatial light modulator 24 is not required to be long such that reflected light from the spatial light modulator 24 is not blocked by the first lens L1. Thus, according to this embodiment, the degree of freedom of the layout of optical elements is increased.

Further, according to this embodiment, since laser light LB passes through the first lens L1 twice, the lens refractive power of the first lens L1 can be weaken, and occurrence of aberration can be inhibited.

Although the first lens L1 and the second lens L2 are each described as one lens in the aforementioned embodiments, the presently disclosed subject matter is not limited thereto. Each of the first lens L1 and the second lens L2 may be a lens group in which one or more lenses are combined.

As mentioned above, according to the first to third embodiments, the optical system (30, 30A and 30B) of the laser machining device 10 can be configured to be compact. Further, if necessary, the entire laser machining device 10 can be relatively small in size, and, at the same time, the distance from the second lens L2 to the machining lens pupil 26a can be long.

In an actual laser machining device, an observation optical system, an AF optical system, optical systems for other kinds of monitoring and the like are required between the second lens L2 and the machining lens pupil 26a, and many optical elements are inserted therebetween. Therefore, the distance from the second lens L2 to the machining lens pupil 26a is required to be long.

However, increasing the focal length f₂ of the second lens L2 correspondingly increases the focal length f₁ of the first lens L1, which increases the size of the entire device. In other words, f₂ = D is required in the 4F optical system illustrated in FIG. 10.

On the other hand, since f₂(1 - M) = D is adopted in the optical system (30, 30A and 30B) according to the aforementioned embodiments, the focal length f₂ of the second lens L2 can be reduced. Thus, reduction of the size of the optical system in the laser machining device 10 can be achieved.

### Reference Signs List

10: laser machining device, 12: stage, 20: machining device body, 21: cabinet, 22: laser light source, 24: spatial light modulator, 26: machining lens, 30, 30A, 30B: (relay) optical system, L1: first lens, L2: (second) lens, 32: beam expander, 34: λ/2 wave plate, 50: control device, 52: control unit, 54: movement control unit, 56: laser control unit, 58: spatial light modulator control unit, 60: storage device

What is claimed is:

1. An optical system that relays light to a machining lens to be used for machining on a workpiece, the optical system comprising:
a spatial light modulator; and
a second lens arranged between the spatial light modulator and the machining lens, wherein
a distance D from the second lens to a machining lens pupil is D = f₂ - Mf₂, and
a distance D1 from the spatial light modulator to the second lens is D1 = f₂ - f₂/M, and the spatial light modulator has a conjugate relation with the machining lens pupil of the machining lens,
where f₂ is a focal length of the second lens, and M is a projection magnification from the spatial light modulator to the machining lens pupil of the machining lens.

2. The optical system according to claim 1, further comprising
an afocal optical system including a first lens and the second lens, wherein
the first lens is arranged upstream of the spatial light modulator.

3. The optical system according to claim 1, further comprising
an afocal optical system including a first lens and the second lens, wherein
the first lens is arranged such that light entering the spatial light modulator passes through the first lens, and reflected light reflected by the spatial light modulator after entering the spatial light modulator passes through the first lens.

4. The optical system according to claim 1, wherein:
the spatial light modulator has a condensing function, and
a focal length f₁ of the spatial light modulator is f₁ = -f₂/M.

5. A laser machining device comprising a machining lens, and an optical system according to claim 1, wherein
the spatial light modulator modulates laser light that is radiated with its focal point set inside the workpiece for forming a laser machining region inside the workpiece, and
the optical system relays the laser light modulated by the spatial light modulator to the machining lens.
